(19) United States
(12) Patent Application Publication
(10) Pub. No.: US 2026/0013001 A1
(43) Pub. Date: Jan. 8, 2026

(54) METHODS AND APPARATUSES FOR POSITIONING FOR USER EQUIPMENT CONFIGURED WITH DISCONTINUOUS RECEPTION

(71) Applicant: Lenovo (Beijing) Limited, Beijing (CN)

(72) Inventors: Jie Hu, Beijing (CN); Haiming Wang, Beijing (CN); Jing Han, Beijing (CN); Lihua Yang, Beijing (CN); Luning Liu, Beijing (CN)

(73) Assignee: Lenovo (Beijing) Limited, Beijing (CN)

(21) Appl. No.: 19/111,883

(22) PCT Filed: Sep. 29, 2022
(86) PCT No.: PCT/CN2022/122806

§ 371 Date: Mar. 14, 2025

(51) Int. Cl. H04W 76/28; H04W 52/02; H04W 64/00

(52) U.S. Cl. CPC H04W 76/28; H04W 52/0216; H04W 64/00

(57) ABSTRACT

Embodiments of the present application are related to methods and apparatuses for positioning for a user equipment (UE) configured with discontinuous reception (DRX). An embodiment of the present application provides a UE including: a processor: and a transceiver coupled to the processor and configured to: receive a DRX configuration; and receive a positioning configuration. wherein the DRX configuration is aligned with the positioning configuration.

### TECHNICAL FIELD

The present disclosure generally relates to wireless communications, and especially to positioning for user equipment (UE) configured with discontinuous reception (DRX).

### BACKGROUND OF THE INVENTION

In 3rd Generation Partnership Project (3GPP) Release 17 study for radio resource control (RRC) inactive UEs, no specification impacts are identified for handling the relationship between DRX cycles and positioning requirements in the RRC inactive state. While for 3GPP Release 18 positioning, DRX is considered as an efficient way to reduce power consumption. Furthermore, evaluations of baseline 3GPP Release 17 RRC inactive state positioning with the evaluation assumptions agreed for the study show that the power consumption on a deep sleep state accounts for the highest proportion in the total power consumption. Therefore, coordination between DRX configuration and positioning configuration needs to be considered, especially for low power high accuracy positioning (LPHAP) services.

### SUMMARY

Some embodiments of the present disclosure provide a UE including: a processor; and a transceiver coupled to the processor and configured to: receive a DRX configuration; and receive a positioning configuration, wherein the DRX configuration is aligned with the positioning configuration.

In some embodiments, the DRX configuration includes at least one of a connected DRX (C-DRX) configuration or a paging DRX configuration.

In some embodiments, the positioning configuration includes at least one of a sounding reference signal (SRS) configuration or a positioning reference signal (PRS) configuration.

In some embodiments, the transceiver is configured to: transmit information associated with the DRX configuration to a location management function (LMF); and receive the positioning configuration after transmitting the information associated with the DRX configuration, wherein the positioning configuration is determined by the LMF based at least in part on the information associated with the DRX configuration.

In some embodiments, the information associated with the DRX configuration is transmitted via a long term evolution (LTE) positioning protocol (LPP) message.

In some embodiments, the information associated with the DRX configuration is transmitted to the LMF in response to receiving a DRX configuration request from the LMF.

In some embodiments, the transceiver is configured to transmit the information associated with the DRX configuration in at least one of the following cases: when the UE is an LPHAP UE; when the UE initiates an LPHAP service; or when the DRX configuration is configured, reconfigured, or updated.

In some embodiments, the transceiver is configured to: transmit an on-demand positioning configuration request to an LMF when the processor determines that a current positioning configuration is not aligned with the DRX configuration; and in response to the on-demand positioning configuration request: receive the positioning configuration which is determined by the LMF based at least in part on the on-demand positioning configuration request; or receive an error cause in the case that the LMF fails to determine a requested positioning configuration or the LMF fails to determine a positioning configuration aligned with the DRX configuration.

In some embodiments, the processor is configured to determine that the current positioning configuration is not aligned with the DRX configuration when a time duration of PRS reception determined by the current positioning configuration fully or partly overlaps with a UE inactive duration determined by the DRX configuration.

In some embodiments, the on-demand positioning configuration request is transmitted via an LPP request assistance data message.

In some embodiments, the LPP request assistance data message is transmitted in a mobile originated location request (MO-LR) location service request message.

In some embodiments, the on-demand positioning configuration request indicates at least one of: at least one explicit parameter of a positioning configuration preferred by the UE; a configuration index (ID) of the positioning configuration preferred by the UE; or at least one explicit parameter of the DRX configuration.

In some embodiments, the processor is further configured to start a prohibit timer with a configured value when the transceiver transmits the on-demand positioning configuration request.

In some embodiments, when the prohibit timer is running, the transceiver is configured to: not repeatedly transmit the on-demand positioning configuration request; and/or stop the prohibit timer and trigger another on-demand positioning configuration request to the LMF in the case that the DRX configuration is updated.

In some embodiments, the transceiver is configured to not repeatedly transmit the on-demand positioning configuration request to the LMF in the case that an error cause is received from the LMF in response to the on-demand positioning configuration request.

In some embodiments, the error cause is received via an LPP provide assistance data message.

In some embodiments, the transceiver is configured to transmit the on-demand positioning configuration request to the LMF only if the same request has not been sent before.

In some embodiments, the transceiver is further configured to transmit at least one of the following to a base station (BS) to trigger the BS to transmit information associated with the DRX configuration to an LMF: an indication indicating that the UE is an LPHAP UE; or an indication indicating an LPHAP service requirement.

In some embodiments, the DRX configuration is determined by a BS based at least in part on the positioning configuration.

In some embodiments, the transceiver is further configured to transmit at least one of the following to the BS to trigger the BS to determine the DRX configuration: an indication indicating that the UE is an LPHAP UE; or an indication indicating an LPHAP service requirement.

In some embodiments, the processor is configured to perform a positioning skip in a no-paging paging occasion (PO).

In some embodiments, the positioning skip in the no-paging PO includes at least one of the following: not transmitting a periodic or semi-persistent SRS in the no-paging PO; not receiving a PRS in the no-paging PO; not transmitting a positioning measurement report in the no-paging PO; or not transmitting a positioning measurement report in the no-paging PO in the case that a variation of the positioning measurement report is within a threshold.

In some embodiments, in the case that a positioning measurement report is not transmitted in the no-paging PO, the transceiver is configured to transmit the positioning measurement report with a time stamp in a nearest paging PO.

In some embodiments, the processor is configured to not select resource(s) in a no-paging PO for a small data transmission (SDT).

In some embodiments, the UE is configured or preconfigured with a maximum number of consecutive no-paging POs in which the positioning operation is skipped.

In some embodiments, the processor is configured to: start a configured or preconfigured timer at a beginning of the no-paging PO; and keeping performing the positioning skip in each subsequent no-paging PO until expiration of the timer or a paging PO.

In some embodiments, the processor is configured to stop the timer upon the paging PO.

In some embodiments, the transceiver is configured to receive a paging early indication (PEI) indicating a paging PO, wherein the PEI includes at least one of: an SRS activation or deactivation medium access control (MAC) control element (CE) command; a positioning measurement gap activation or deactivation MAC CE; or a PRS positioning window (PPW) activation or deactivation MAC CE.

In some embodiments, the processor is configured to perform at least one of the following for a positioning operation occurring in a paging PO but not finishing at an end of the paging PO: terminating a periodic or semi-persistent SRS transmission when the paging PO ends; or terminating a PRS reception when the paging PO ends.

In some embodiments, the processor is configured to perform at least one of the following: stopping paging monitoring within a PPW; stopping paging monitoring within a positioning response duration when a positioning measurement report is skipped due to at least one pre-defined condition being fulfilled; or stopping monitoring a physical downlink control channel (PDCCH) or a PO when a positioning measurement report is transmitted before an end of a positioning response duration.

In some embodiments, the at least one pre-defined condition includes: the positioning measurement report being not changed; or a variation of the positioning measurement report being within a threshold.

Some embodiments of the present disclosure provide a BS including: a processor; and a transceiver coupled to the processor and configured to perform at least one of: transmitting a first DRX configuration aligned with a first positioning configuration to a UE; or transmitting information associated with a second DRX configuration to an LMF for the LMF to determine a second positioning configuration aligned with the second DRX configuration.

In some embodiments, the first DRX configuration includes at least one of a C-DRX configuration or a paging DRX configuration, and the second DRX configuration includes at least one of a C-DRX configuration or a paging DRX configuration.

In some embodiments, the first positioning configuration includes at least one of an SRS configuration or a PRS configuration, and the second positioning configuration includes a PRS configuration.

In some embodiments, the transceiver is further configured to: in response to transmitting the information associated with the second DRX configuration, receive the second positioning configuration from the LMF before transmitting a PRS to the UE.

In some embodiments, the transceiver is configured to transmit the information associated with the second DRX configuration to the LMF in response to receiving a DRX configuration request from the LMF.

In some embodiments, the transceiver is configured to transmit the information associated with the second DRX configuration to the LMF in response to at least one of: receiving, from the UE, an indication indicating that the UE is An LPHAP UE; receiving, from the UE or from the LMF, an indication indicating an LPHAP service requirement; the second DRX configuration being configured, reconfigured, or updated; or the UE performing a cell reselection or handover.

In some embodiments, the processor is configured to determine the first DRX configuration based at least in part on the first positioning configuration in response to at least one of the following: an indication, from the UE, indicating that the UE is an LPHAP UE; an indication, from the UE or from an LMF, indicating an LPHAP service requirement; or an indication, from the LMF, indicating that the first DRX configuration is needed to be aligned with the first positioning configuration.

In some embodiments, the transceiver is further configured to receive the first positioning configuration from the LMF before the processor determines the first DRX configuration.

In some embodiments, in the case that the first DRX configuration is a paging DRX configuration, the processor is configured to coordinate the first DRX configuration with at least one neighboring cell.

In some embodiments, in the case that the UE moves to or select a new cell within a configured positioning area where a current positioning configuration is maintained, the processor is configured to transmit an alignment indication indicating that a current DRX configuration is aligned with the current positioning configuration to the new cell to maintain an alignment.

In some embodiments, in the case that the UE performs a handover or a cell reselection to a target BS, the transceiver is configured to transmit, to the target BS, at least one of: an indication indicating a need of alignment between a current positioning configuration and a current DRX configuration, or alignment information regarding the current positioning configuration and the current DRX configuration.

In some embodiments, the at least one of the indication or the alignment information is transmitted in a handover request message.

In some embodiments, the alignment information includes at least one of: the UE being an LPHAP UE; an LPHAP service requirement; an indication indicating alignment between the current DRX configuration and the current positioning configuration; information associated with the current positioning configuration; or information associated with the current DRX configuration.

In some embodiments, the transceiver is further configured to transmit a PEI indicating a paging PO in response to receiving a positioning configuration or update from an LMF, wherein the PEI includes at least one of: an SRS activation or deactivation MAC CE command; a positioning measurement gap activation or deactivation MAC CE; or a PPW activation or deactivation MAC CE.

Some embodiments of the present disclosure provide a BS including: a processor; and a transceiver coupled to the processor and configured to transmit at least one of: a first positioning configuration aligned with a first DRX configuration; or a first indication for triggering a BS to determine a second DRX configuration aligned with a second positioning configuration.

In some embodiments, the first DRX configuration includes at least one of a C-DRX configuration or a paging DRX configuration, and the second DRX configuration includes at least one of a C-DRX configuration or a paging DRX configuration.

In some embodiments, the first positioning configuration includes a PRS configuration, and the second positioning configuration includes at least one of an SRS configuration or a PRS configuration.

In some embodiments, the transceiver is further configured to receive information associated with the first DRX configuration from a UE or from a BS, and the processor is configured to determine the first positioning configuration based at least in part on the information associated with the first DRX configuration before the transceiver transmits the first positioning configuration.

In some embodiments, the transceiver is further configured to transmit a DRX configuration request to the UE or to the BS for the information associated with the first DRX configuration.

In some embodiments, the information associated with the first DRX configuration is received via an LPP message.

In some embodiments, the transceiver is further configured to receive an on-demand positioning configuration request from a UE, and the processor is configured to determine the first positioning configuration based at least in part on the on-demand positioning configuration request before the transceiver transmits the first positioning configuration.

In some embodiments, the on-demand positioning configuration request is received via an LPP request assistance data message.

In some embodiments, the LPP request assistance data message is received in an MO-LR location service request message.

In some embodiments, the on-demand positioning configuration request includes at least one of: at least one explicit parameter of a positioning configuration preferred by the UE; an ID of the positioning configuration preferred by the UE; or at least one explicit parameter of the first DRX configuration.

In some embodiments, the transceiver is further configured to transmit an error cause in the case that the processor fails to determine a requested positioning configuration or the processor fails to determine a positioning configuration aligned with the first DRX configuration.

In some embodiments, the error cause is transmitted via an LPP provide assistance data message.

In some embodiments, the transceiver is further configured to transmit a second indication for triggering the BS to transmit information associated with the first DRX configuration to the LMF, wherein the second indication indicates an LPHAP service requirement.

In some embodiments, the first indication includes at least one of the following: an indication indicating an LPHAP service requirement; or an indication indicating that the second DRX configuration is needed to be aligned with the second positioning configuration.

Some embodiments of the present disclosure provide a method performed by an LMF. The method includes: receiving a DRX configuration; and receiving a positioning configuration, wherein the DRX configuration is aligned with the positioning configuration.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 illustrates a flowchart of an exemplary method performed by a UE according to some embodiments of the present disclosure.

FIG. 3 illustrates a flowchart of an exemplary method for alignment between DRX configuration and positioning configuration according to some embodiments of the present disclosure.

FIG. 4 illustrates a flowchart of another exemplary method for alignment between DRX configuration and positioning configuration according to some embodiments of the present disclosure.

FIG. 5 illustrates a flowchart of another exemplary method for alignment between DRX configuration and positioning configuration according to some embodiments of the present disclosure.

FIG. 6 illustrates a flowchart of another exemplary method for alignment between DRX configuration and positioning configuration according to some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) long term evolution (LTE), LTE advanced, 5G new radio (NR), 5G-Advanced, 6G, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

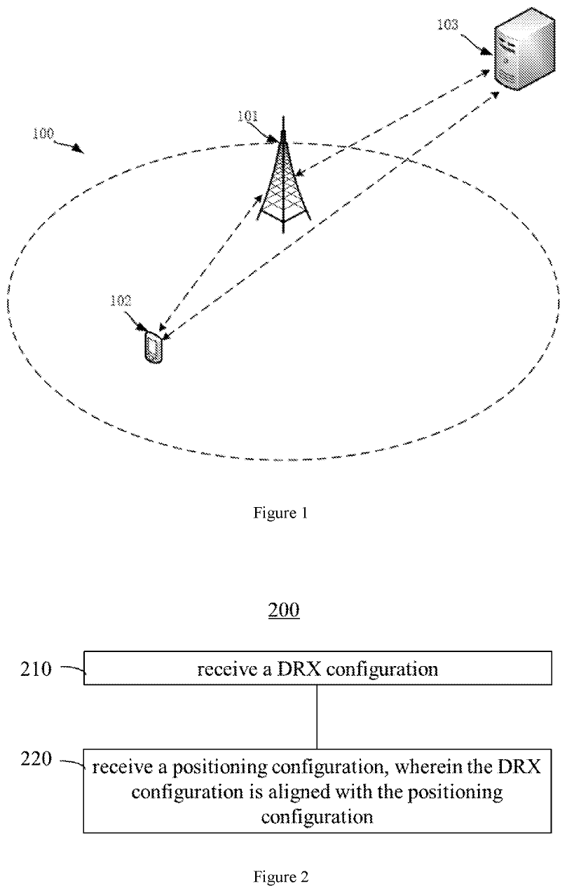

FIG. 1 is a schematic diagram illustrating an exemplary wireless communication system 100 according to some embodiments of the present disclosure.

As shown in FIG. 1, the wireless communication system 100 includes at least one BS 101, at least one UE 102, and at least one LMF 103. Although one BS, one UEs, and one LMF are depicted in FIG. 1 for illustrative purpose, it is contemplated that any number of BSs, UEs, and LMFs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a radio access network (RAN) node, a next generation (NG) RAN node, a node-B, an enhanced node B (eNB), a gNB, a home node-B, a relay node, or a device, or described using other terminology used in the art. The BS 101 is generally part of a RAN that may include a controller communicably coupled to the BS 101.

According to some embodiments of the present application, the UE 102 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102 may be an LPHAP UE.

According to some other embodiments of the present application, the UE 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102 may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

In the example shown in FIG. 1, the UE 102 is in a coverage area of the BS 101, and may communicate with the BS 101, for example, via LTE or NR Uu interface.

The LMF 103 (also referred to as LMF entity) may refer to a network element or network entity for supporting location services, which may be deployed in a core network (CN) or in a RAN of the wireless communication system 100. The LMF 103 may communicate with the BS 101 via NR positioning protocol A (NRPPa) signaling, and may communicate with the UE 102 via LTE positioning protocol (LPP) signaling. In the present disclosure, both LMF and BS may be referred to as a network entity or the network.

In 3GPP Release 17 study, no specification impacts are identified for handling the relationship between DRX cycle and positioning requirements for a UE in an RRC inactive state. While for 3GPP Release 18 positioning, DRX is considered as an efficient way to reduce power consumption, and evaluations of baseline 3GPP Release 17 positioning for a UE in an RRC inactive state with the evaluation assumptions agreed for the study show that the power consumption on a deep sleep state accounts for the highest proportion in the total power consumption, which means the UE's transmission/reception behaviors (e.g., PRS reception and SRS transmission) are suggested to be performed in active time when the UE is configured with DRX for power saving purpose. The principle can also be considered for an LPHAP UE. Therefore, DRX impact on positioning is suggested to be studied for a UE (e.g., an LPHAP UE). The present disclosure proposes that the positioning operations should be aligned with the DRX configuration for power saving. In other words, the DRX configuration and the positioning configuration should be aligned.

The present disclosure at least provides various solutions for implementing alignment between the positioning configuration and the DRX configuration, especially for an LPHAP UE, and the case that the UE performs a handover or cell reselection procedure is also considered.

In some embodiments, the positioning configuration may include at least one of a PRS configuration or an SRS configuration. The PRS configuration may be determined by an LMF (e.g., the LMF 103) and transmitted by the LMF to a BS (e.g., the BS 101) and a UE (e.g., the UE 102), such that the BS may transmit PRS according to the PRS configuration, and the UE may receive the PRS according to the PRS configuration. The SRS configuration may be determined by a BS (e.g., the BS 101) and transmitted by the BS to a UE (e.g., the UE 102), such that the UE may transmit SRS according to the SRS configuration.

In some embodiments, the DRX configuration may include at least one of a C-DRX configuration or a paging DRX configuration. The C-DRX configuration may be determined by a BS for a UE in the RRC connected state, and when C-DRX is configured, the UE does not have to continuously monitor PDCCH. The paging DRX configuration is defined when a UE in the RRC idle state or the RRC inactive state is only required to monitor paging channels during one PO per DRX cycle. The paging DRX cycles are configured by a network for the UE: for CN-initiated paging, a default cycle is broadcasted in system information by a BS, and a UE specific cycle can be configured via Non-Access Stratum (NAS) signalling; for RAN-initiated paging, a UE-specific cycle is configured via RRC signalling from a BS. The UE uses the shortest of the DRX cycles applicable, i.e., when the UE is in the RRC idle state, it may use the shortest of the first two of the above three cycles, while when the UE is in the RRC inactive state, it may use the shortest of the above three cycles.

FIG. 2 illustrates a flowchart of an exemplary method 200 performed by a UE (e.g., the UE 102 in FIG. 1) according to some embodiments of the present disclosure. It is contemplated that the method 200 may also be performed by other devices with similar functions.

In step 210, the UE may receive a DRX configuration. The DRX configuration may be received from a BS (e.g., the BS 101 in FIG. 1). In step 220, the UE may receive a positioning configuration, wherein the DRX configuration is aligned with the positioning configuration. The positioning configuration may be received from the BS or an LMF (e.g., the LMF 103 in FIG. 1). In some embodiments, the positioning configuration is received after the reception of the DRX configuration. In some other embodiments, the positioning configuration is received before the reception of the DRX configuration.

The alignment between the DRX configuration and the positioning configuration may be achieved by various methods, which will be described below. In some embodiments, the LMF performs alignment between the DRX configuration and the positioning configuration. In some other embodiments, the BS performs alignment between the DRX configuration and the positioning configuration.

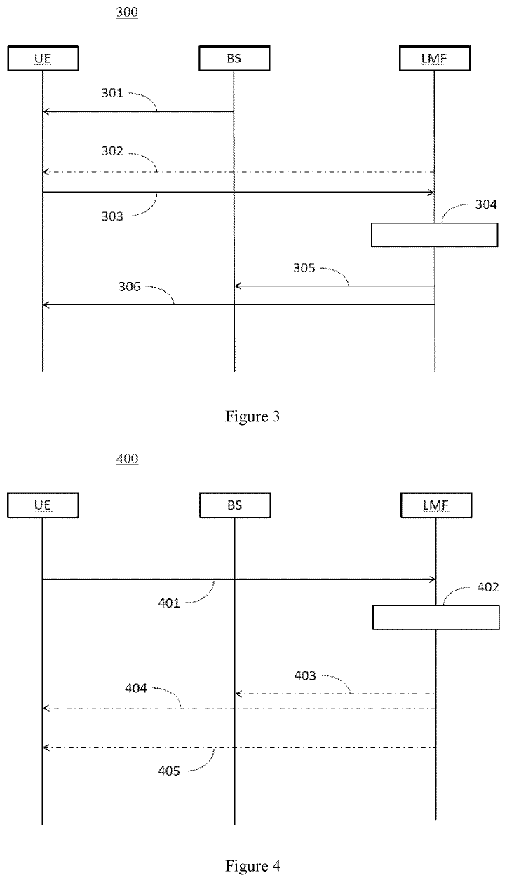

FIG. 3 illustrates a flowchart of an exemplary method 300 for alignment between DRX configuration and positioning configuration according to some embodiments of the present disclosure. It is contemplated that for concise and simplicity, only necessary steps embodying the spirit of the present disclosure is shown in FIG. 3. The method illustrated in FIG. 3 may be performed by at least three network entities, e.g., a UE, a BS, and an LMF. Although the method is illustrated in a system level, persons skilled in the art can understand that the method implemented in the three network entities can be separately implemented and incorporated in other apparatus with the like functions.

As shown in FIG. 3, the UE (e.g., the UE 102 in FIG. 1) may receive a DRX configuration from the BS (e.g., the BS 101 in FIG. 1) in step 301. In step 303, the UE may transmit information associated with the DRX configuration to the LMF (e.g., the LMF 103). In step 304, the LMF may determine a positioning configuration (e.g., a PRS configuration), which is aligned with the DRX configuration, based at least in part on the received information associated with the DRX configuration. Then, the LMF may transmit the determined positioning configuration to the BS (in step 305) and to the UE (in step 306). Step 305 may be performed before, after, or simultaneously with step 306.

In some embodiments, step 303 may be performed in response to a request from the LMF. For example, the LMF may transmit a DRX configuration request to the UE in step 302. In response to the DRX configuration request, the UE may transmit the information associated with the DRX configuration to the LMF in step 303.

In some other embodiments, step 303 may be an unsolicited action (i.e., the UE may perform step 303 without receiving any request from the LMF). For example, the UE may transmit the information associated with the DRX configuration via an LPP message, e.g., an LPP request assistance data message (e.g., RequestAssistanceData) or a separated LPP message. In some embodiments, the UE may transmit the information associated with the DRX configuration in at least one of the following cases:
When the UE is an LPHAP UE;
When the UE initiates an LPHAP service; or
When the DRX configuration is configured, reconfigured, or updated.

FIG. 4 illustrates a flowchart of an exemplary method 400 for alignment between DRX configuration and positioning configuration according to some embodiments of the present disclosure. It is contemplated that for concise and simplicity, only necessary steps embodying the spirit of the present disclosure is shown in FIG. 4. The method illustrated in FIG. 4 may be performed by at least three network entities, e.g., a UE, a BS, and an LMF. Although the method is illustrated in a system level, persons skilled in the art can understand that the method implemented in the three network entities can be separately implemented and incorporated in other apparatus with the like functions.

As shown in FIG. 4, in step 401, the UE (e.g., the UE 102 in FIG. 1) may transmit an on-demand positioning configuration request to the LMF (e.g., the LMF 103 in FIG. 1) for acquiring a positioning configuration (e.g., a PRS configuration). The on-demand positioning configuration request may be transmitted when the UE determines that a current positioning configuration is not aligned with a current DRX configuration (which was received from the BS previously), for example, when a time duration of PRS reception determined by the current positioning configuration fully or partly overlaps with a UE inactive duration determined by the current DRX configuration.

In some embodiments, the UE may transmit the on-demand positioning configuration request to the LMF via an LPP request assistance data message. In some embodiments, the LPP request assistance data message may be transmitted in an MO-LR location service request message.

In some embodiments, the on-demand positioning configuration request may indicate at least one of:
at least one explicit parameter of a positioning configuration preferred by the UE;
an ID of the positioning configuration preferred by the UE; or
at least one explicit parameter of the current DRX configuration.

After receiving the on-demand positioning configuration request, the LMF may try to determine a new positioning configuration based at least in part on the on-demand positioning configuration request in step 402. In the case that the LMF determines the new positioning configuration successfully, the LMF may transmit the new positioning configuration to the BS (in step 403) and to the UE (in step 404). Step 403 may be performed before, after, or simultaneously with step 404. In the case that the LMF fails to determine a new positioning configuration in response to an explicit positioning configuration request (e.g., a request indicating at least one explicit parameter or an ID of a preferred positioning configuration) from the UE, or the LMF fails to determine a new positioning configuration aligned with the current DRX configuration, the LMF may transmit an error cause to the UE in step 405, e.g., via an LPP provide assistance data message. In some embodiments, when the UE receives the error cause from the LMF after transmitting the on-demand positioning configuration request, the UE will not repeatedly transmit the same request to the LMF.

In some embodiments, the UE may start a prohibit timer with a configured value when the UE transmits the on-demand positioning configuration request. In some embodiments, when the prohibit timer is running, the UE may not repeatedly transmit the same on-demand positioning configuration request to the LMF. In some embodiments, the current DRX configuration may be updated or re-configured when the prohibit timer is running. In such cases, the UE may stop the prohibit timer and trigger a new on-demand positioning configuration request to the LMF.

In some embodiments, the UE may transmit the on-demand positioning configuration request to the LMF only if the same request has not been sent to the LMF before.

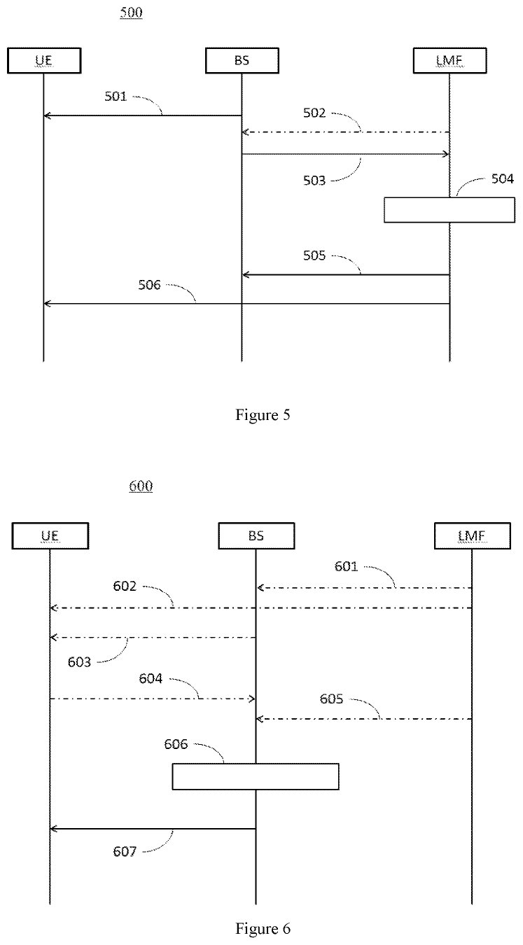

FIG. 5 illustrates a flowchart of an exemplary method 500 for alignment between DRX configuration and positioning configuration according to some embodiments of the present disclosure. It is contemplated that for concise and simplicity, only necessary steps embodying the spirit of the present disclosure is shown in FIG. 5. The method illustrated in FIG. 5 may be performed by at least three network entities, e.g., a UE, a BS, and an LMF. Although the method is illustrated in a system level, persons skilled in the art can understand that the method implemented in the three network entities can be separately implemented and incorporated in other apparatus with the like functions.

As shown in FIG. 5, the BS (e.g., the BS 101 in FIG. 1) may transmit a DRX configuration to the UE (e.g., the UE 102 in FIG. 1) in step 501. In step 503, the BS may transmit information associated with the DRX configuration to the LMF (e.g., the LMF 103 in FIG. 1) for the LMF to determine a positioning configuration (e.g., a PRS configuration) aligned with the DRX configuration. Step 501 may be performed before, after, or simultaneously with step 503.

In step 504, the LMF may determine the positioning configuration aligned with the DRX configuration based at least in part on the information received in step 503. Then, the LMF may transmit the determined positioning configuration to the BS (in step 505) and to the UE (in step 506).

In some embodiments, step 503 may be performed in response to a request from the LMF. For example, the LMF may transmit a DRX configuration request to the BS in step 502. In response to the DRX configuration request, the BS may transmit the information associated with the DRX configuration to the LMF in step 503.

In some other embodiments, step 503 may be an unsolicited action (i.e., the BS may perform step 503 without receiving any request from the LMF). For example, the BS may transmit the information associated with the DRX configuration to the LMF in at least one of the following cases:
When the BS receives, from the UE, an indication indicating that the UE is an LPHAP UE;
When the BS receives, from the UE or from the LMF, an indication indicating an LPHAP service requirement;
When the DRX configuration is configured, reconfigured, or updated; or
When the UE performs a cell reselection or handover.

FIG. 6 illustrates a flowchart of an exemplary method 600 for alignment between DRX configuration and positioning configuration according to some embodiments of the present disclosure. It is contemplated that for concise and simplicity, only necessary steps embodying the spirit of the present disclosure is shown in FIG. 6. The method illustrated in FIG. 6 may be performed by at least three network entities, e.g., a UE, a BS, and an LMF. Although the method is illustrated in a system level, persons skilled in the art can understand that the method implemented in the three network entities can be separately implemented and incorporated in other apparatus with the like functions.

As shown in FIG. 6, in some embodiments, the LMF (e.g., the LMF 103 in FIG. 1) may determine a first positioning configuration (e.g., a PRS configuration), and transmit the first positioning configuration to the BS (in step 601) and to the UE (in step 602). Step 601 may be performed before, after, or simultaneously with step 602. Additionally or alternatively, the BS (e.g., the BS 101 in FIG. 1) may determine a second positioning configuration (e.g., an SRS configuration), and transmit the second positioning configuration to the UE (e.g., the UE 102 in FIG. 1) in step 603. Step 603 may be performed before, after, or simultaneously with step 601 or step 602.

In some embodiments, the BS may receive an indication from the UE (in step 604) or from the LMF (in step 605) which indicates the BS to perform alignment between DRX configuration and positioning configuration. The indication may include at least one of the following:
an indication, from the UE, indicating that the UE is an LPHAP UE;
an indication, from the UE or from the LMF, indicating an LPHAP service requirement; or
an indication, from the LMF, indicating that the DRX configuration is needed to be aligned with the positioning configuration.

In response to the indication, in step 606, the BS may determine a DRX configuration based at least in part on a positioning configuration, e.g., the first positioning configuration received from the LMF and/or the second positioning configuration determined by the BS. Then, the BS may transmit the determined DRX configuration to the UE in step 607.

In some embodiments, in the case that a DRX configuration is configured already when the indication is received, the BS may determine and transmit a new DRX configuration to the UE to align with the positioning configuration as possible, where the new DRX configuration may be a full DRX configuration or delta DRX configuration (e.g., update for at least one parameter) compared with the previous DRX configuration. In some embodiments, in the case that a DRX configuration is being configured when the indication is received, the BS may determine and transmit a DRX configuration to the UE to align with the positioning configuration as possible.

In some embodiments, in the case that the determined DRX configuration is a paging DRX configuration, the BS may coordinate the paging DRX configuration of the UE with at least one neighboring cell. The paging DRX configuration may include at least one of a cell-specific paging DRX configuration which is provided in a system information block (SIB) message and a UE-specific paging DRX configuration which is provided by RRC signalling. That is to say, the serving BS may coordinate the paging DRX configuration with neighboring cell(s) that the UE may reselect to in an RRC inactive state or in an RRC idle state to make the neighboring cell(s) be aware of the current paging DRX configuration of the UE and provide a similar DRX configuration to the UE.

In some other embodiments, in step 606, the BS may determine a new positioning configuration (e.g., SRS configuration) aligned with a current DRX configuration in response to receiving the indication in step 604 or 605, and transmit the new positioning configuration to the UE in step 607.

According to some embodiments of the present disclosure, in some cases, a positioning area where a current positioning configuration is maintained may be configured to a UE. The positioning area is defined as follows: a positioning configuration is valid when a UE moves within the same positioning area. The positioning area may consist of one or more cells. When the UE moves to or selects a new cell within the configured positioning area, the previous serving BS may coordinate a current DRX configuration aligned with the current positioning configuration with the new cell to maintain an alignment between the current DRX configuration and the current positioning configuration in the positioning area. In some embodiments, the coordination performed by the previous serving BS may include transmitting an alignment indication which indicates that the current DRX configuration is aligned with the current positioning configuration to the new cell in the same positioning area.

In the case that no such positioning area is configured, when the UE performs a handover or a cell reselection to a target BS from a source BS, the source BS may transmit, to the target BS, at least one of:
an indication indicating a need of alignment between a current positioning configuration and a current DRX configuration, or
alignment information regarding the current positioning configuration and the current DRX configuration.

The at least one of the indication or the alignment information may be transmitted in a handover request message. In some embodiments, the alignment information may include at least one of:
the UE being an LPHAP UE;
an LPHAP service requirement;
an indication indicating alignment between the current DRX configuration and the current positioning configuration;
information associated with the current positioning configuration; or
information associated with the current DRX configuration.

According to some embodiments of the present disclosure, paging DRX for a UE in the RRC inactive state or in the RRC idle state may be configured with PEI, wherein a PEI may indicate whether a subsequent PO is a paging PO (i.e., paging may be transmitted in this PO) or a no-paging PO (i.e., no paging in this PO).

In some embodiments, when a BS receives a PRS configuration or PRS configuration update from an LMF, the BS may transmit a PEI indicating a paging PO to a UE. The PEI may include at least one of:
an SRS activation or deactivation MAC CE command;
a positioning measurement gap activation or deactivation MAC CE command; or
a PPW activation or deactivation MAC CE command.

In some embodiments, a UE may perform a positioning skip in a no-paging PO. On advantage of the positioning skip in a no-paging PO is for power saving. The positioning skip in the no-paging may include at least one of the following:
not transmitting a periodic or semi-persistent SRS in the no-paging PO;
not receiving a PRS in the no-paging PO;
not transmitting a positioning measurement report in the no-paging PO; or.
not transmitting a positioning measurement report in the no-paging PO in the case that a variation of the positioning measurement report is within a threshold.

In some embodiments, in the case that the UE does not transmit a positioning measurement report in a no-paging PO, the UE may transmit the positioning measurement with a time stamp associated with the no-paging PO in the nearest later paging PO.

In some embodiments, the UE may not select resource(s) in the no-paging PO for SDT.

In some embodiments, the UE may be configured or preconfigured with a maximum number of consecutive no-paging POs in which the positioning operation is skipped. That is to say, after performing the positioning skip in the maximum number of consecutive no-paging POs, the UE may not perform the positioning skip in the next PO even if a PEI indicates that the next PO is still a no-paging PO. This is to avoid a long time duration without performing positioning operations. The maximum number of consecutive no-paging POs guarantees the positioning quality of service (QoS).

In some embodiments, the UE may start a configured or preconfigured timer at a beginning of a no-paging PO, and keep performing the positioning skip in each subsequent no-paging PO until the timer expires, or until the UE receives a PEI indicating a paging PO (i.e., until a paging PO). The UE may stop the timer upon reception of the PEI indicating the paging PO (i.e., upon the paging PO).

In some embodiments, the UE may perform at least one of the following for a positioning operation occurring in a paging PO but not finishing at the end of the paging PO (e.g., a PPW or positioning response duration lasts to an out-of-PO duration):
terminating a periodic or semi-persistent SRS transmission when the paging PO ends (i.e., the paging PO duration stops); or
terminating a PRS reception when the paging PO ends.

In some embodiments, when, for example, a UE (e.g., an LPHAP UE or a UE having similar functions) is mainly used for tracking workpiece(s) in an assembly area and/or warehouse, there may be no other service requirements except for positioning for the UE. In such cases, it may be worth relaxing PO monitoring and/or measurement based on the time characteristic of positioning services for the UE for power saving. Specifically, in some embodiments, the UE may perform at least one of the following:
stopping paging monitoring within a PPW;
stopping paging monitoring within a positioning response duration when a positioning measurement report is skipped due to at least one pre-defined condition being fulfilled, wherein the at least one pre-defined condition may include:
   the positioning measurement report being not changed; or
   a variation of the positioning measurement report being within a configured or pre-defined threshold; or
stopping monitoring a PDCCH or a PO when a positioning measurement report is transmitted before an end of a positioning response duration.

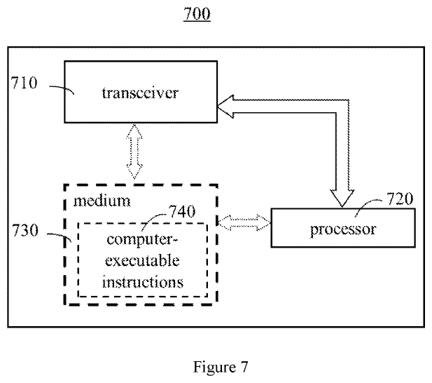

FIG. 7 illustrates a simplified block diagram of an exemplary apparatus 700 according to some embodiments of the present disclosure.

In some embodiments, the apparatus 700 may be or include at least part of a UE which is capable of performing any of the operations performed by a UE as described in the present disclosure (e.g., in the method described with respect to any of FIGS. 2-6).

In some embodiments, the apparatus 700 may be or include at least part of a BS which is capable of performing any of the operations performed by a BS as described in the present disclosure (e.g., in the method described with respect to any of FIGS. 2-6).

In some embodiments, the apparatus 700 may be or include at least part of an LMF which is capable of performing any of the operations performed by an LMF as described in the present disclosure (e.g., in the method described with respect to any of FIGS. 2-6).

As shown in FIG. 7, the apparatus 700 may include at least a transceiver 710 and a processor 720 coupled to transceiver 710. In some embodiments, the transceiver 710 may include a transmitter and a receiver integrated together. In some embodiments, the transceiver 710 may include a transmitter and a receiver which are separated from each other. In some embodiments, the transceiver 710 may be a wireless transceiver.

In some embodiments, the apparatus 700 may include a non-transitory computer-readable medium 730 with computer-executable instructions 740 stored thereon. The non-transitory computer-readable medium 730 may be coupled to the processor 720 and the transceiver 710, and the computer-executable instructions 740 may be configured to be executable by the processor 720. In some embodiments, the transceiver 710, the non-transitory computer-readable medium 730, and the processor 720 may be coupled to each other via one or more local buses.

Although in FIG. 7, elements such as the transceiver 710, the non-transitory computer-readable medium 730, and the processor 720 are described in the singular, the plural is contemplated unless limitation to the singular is explicitly stated. In certain embodiments of the present disclosure, the apparatus 700 may further include other components for actual usage.

In various example embodiments, the processor 720 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 720 may also include at least one other circuitry or element not shown in FIG. 7.

In various example embodiments, the non-transitory computer-readable medium 730 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable medium 730 may include, but is not limited to, an electric, a magnetic, an optical, an electromagnetic, an infrared, or a semiconductor system, apparatus, or device or any combination of the above.

Further, in various example embodiments, the apparatus 700 may also include at least one other circuitry, element, and interface, for example antenna element, and the like.

According to some embodiments, the apparatus 700 is a UE. The transceiver 710 and the processor 720 may be configured to perform operations in any methods described above which are performed by a UE. For example, the transceiver 710 may be configured to receive a DRX configuration, and receive a positioning configuration, wherein the DRX configuration is aligned with the positioning configuration.

According to some embodiments, the apparatus 700 is a BS. The transceiver 710 and the processor 720 may be configured to perform operations in any methods described above which are performed by a BS. For example, the transceiver 710 may be configured to perform at least one of: transmitting a first DRX configuration aligned with a first positioning configuration to a UE; or transmitting information associated with a second DRX configuration to an LMF for the LMF to determine a second positioning configuration aligned with the second DRX configuration.

According to some embodiments, the apparatus 700 is an LMF. The transceiver 710 and the processor 720 may be configured to perform operations in any methods described above which are performed by an LMF. For example, the transceiver 710 may be configured to transmit at least one of: a first positioning configuration aligned with a first DRX configuration; or a first indication for triggering a BS to determine a second DRX configuration aligned with a second positioning configuration.

In various example embodiments, the circuitry, parts, elements, and interfaces in exemplary apparatus, including processor and non-transitory computer-readable medium, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory
and configured to cause the UE to:
receive a discontinuous reception (DRX) configuration; and
receive a positioning configuration, wherein the DRX configuration is aligned with the positioning configuration.

2. The UE of claim 1, wherein the at least one processor is further configured to cause the UE to:
transmit information associated with the DRX configuration to a location management function (LMF); and
receive the positioning configuration after transmitting the information associated with the DRX configuration.

3. The UE of claim 2, wherein to transmit the information associated with the DRX configuration to the LMF, the at least one processor is further configured to transmit the information associated with the DRX configuration to the LMF in response to receiving a DRX configuration request from the LMF.

4. The UE of claim 2, wherein the at least one processor is further configured to cause the UE to transmit the information associated with the DRX configuration at least one of:
when the UE is a low power high accuracy positioning (LPHAP) UE;
when the UE initiates an LPHAP service; or
when the DRX configuration is configured, reconfigured, or updated.

5. The UE of claim 1, wherein the at least one processor is further configured to cause the UE to:
transmit an on-demand positioning configuration request to location management function (LMF) when the processor determines that a current positioning configuration is not aligned with the DRX configuration; and
in response to the on-demand positioning configuration request:
receive the positioning configuration; or
receive an error cause.

6. The UE of claim 5, wherein the at least one processor is further configured to cause the UE to determine that the current positioning configuration is not aligned with the DRX configuration when a time duration of positioning reference signal (PRS) reception determined by the current positioning configuration fully or partly overlaps with a UE inactive duration determined by the DRX configuration.

7. The UE of claim 5, wherein the on-demand positioning configuration request indicates at least one of:
at least one explicit parameter of a positioning configuration preferred by the UE; or
a configuration index (ID) of the positioning configuration preferred by the UE.

8. The UE of claim 5, wherein the at least one processor is further configured to cause the UE to start a prohibit timer with a configured value when the UE transmits the on-demand positioning configuration request, and wherein when the prohibit timer is running, the at least one processor is further configured to cause the UE to:
not repeatedly transmit the on-demand positioning configuration request; or
stop the prohibit timer and trigger another on-demand positioning configuration request to the LMF in a case that the DRX configuration is updated.

9. The UE of claim 1, wherein the at least one processor is further configured to cause the UE to transmit, to a base station (BS) to trigger the BS to transmit information associated with the DRX configuration to an LMF, at least one of:
an indication indicating that the UE is a low power high accuracy positioning (LPHAP) UE; or
an indication indicating an LPHAP service requirement.

10. The UE of claim 1, wherein the at least one processor is further configured to cause the UE to transmit, to trigger a base station (BS) to determine the DRX configuration:
an indication indicating that the UE is a low power high accuracy positioning (LPHAP) UE; or
an indication indicating an LPHAP service requirement.

11. The UE of claim 1, wherein the at least one processor is further configured to cause the UE to:
stop paging monitoring within a positioning reference signal (PRS) positioning window (PPW);
stop paging monitoring within a positioning response duration when a positioning measurement report is skipped due to at least one pre-defined condition being fulfilled; or
stop monitoring a physical downlink control channel (PDCCH) or a paging occasion (PO) when a positioning measurement report is transmitted before an end of a positioning response duration.

12. A base station (BS) for wireless communication, comprising:
at least one memory; and
at least one processor coupled with the at least one memory
and configured to cause the BS to at least one of:
transmit a first discontinuous reception (DRX) configuration aligned with a first positioning configuration to a user equipment (UE); or
transmit information associated with a second DRX configuration to a location management function (LMF) for the LMF to determine a second positioning configuration aligned with the second DRX configuration.

13. The BS of claim 12, wherein in a case that the UE performs a handover or a cell reselection to a target BS, the at least one processor is further configured to cause the BS to transmit, to the target BS, at least one of: an indication indicating a need of alignment between a current positioning configuration and a current DRX configuration, or alignment information regarding the current positioning configuration and the current DRX configuration.

14. (canceled)

15. A method performed by a user equipment (UE), the method comprising:
receiving a discontinuous reception (DRX) configuration; and
receiving a positioning configuration, wherein the DRX configuration is aligned with the positioning configuration.

16. The method of claim 15, further comprising:
determining that a current positioning configuration is not aligned with the DRX configuration; and
transmitting an on-demand positioning configuration request to location management function (LMF) based at least in part on determining that a current positioning configuration is not aligned with the DRX configuration; and
in response to the on-demand positioning configuration request:
receiving the positioning configuration; or
receiving an error cause.

17. The method of claim 16, wherein further comprising determining that the current positioning configuration is not aligned with the DRX configuration when a time duration of positioning reference signal (PRS) reception determined by the current positioning configuration fully or partly overlaps with a UE inactive duration determined by the DRX configuration.

18. The method of claim 16, wherein the on-demand positioning configuration request indicates at least one of:
at least one explicit parameter of a positioning configuration preferred by the UE; or
a configuration index (ID) of the positioning configuration preferred by the UE.

19. The method of claim 16, wherein transmitting the on-demand positioning configuration comprises transmitting the on-demand positioning configuration request via a long term evolution (LTE) positioning protocol (LPP) request assistance data message.

20. A method performed by a base station (BS), the method comprising:
transmitting a first discontinuous reception (DRX) configuration aligned with a first positioning configuration to a user equipment (UE); or
transmitting information associated with a second DRX configuration to a location management function (LMF) for the LMF to determine a second positioning configuration aligned with the second DRX configuration.

21. The UE of claim 5, wherein to transmit the on-demand positioning configuration request, the at least one processor is further configured to cause the UE to transmit the on-demand positioning configuration request via a long term evolution (LTE) positioning protocol (LPP) request assistance data message.
